(19) United States
(12) Patent Application Publication
(10) Pub. No.: US 2006/0152577 A1
(43) Pub. Date: Jul. 13, 2006

(54) Systems and methods for incorporating video into voice-only call centers

(76) Inventors: Pierre Hagendorf, Ra'anana (IL); Roy Muchtar, Moshav Sdei Hemed (IL)

Correspondence Address: WILMER CUTLER PICKERING HALE AND DORR LLP, 399 PARK AVENUE, NEW YORK, NY, 10022, US

(21) Appl. No.: 11/300,120

(22) Filed: Dec. 13, 2005

Related U.S. Application Data
(60) Provisional application No. 60/635,656, filed on Dec. 13, 2004.

(51) Int. Cl. H04N 7/14

(52) U.S. Cl. 348/14.01; 379/93.01

(57) ABSTRACT

Systems and methods for incorporating video into voice-only call centers are provided. These systems and methods incorporate video by separating the video from the audio portion of incoming calls, routing the audio through the voice-only system to an agent telephone, routing the video separately from the audio to an agent terminal, and re-joining the video with the audio for outgoing portions of the call.

### CROSS-REFERENCE(S) TO RELATED APPLICATIONS

The present application claims the benefit of provisional application 60/635,656, filed on Dec. 13, 2004, the content of which is hereby incorporated by reference herein in its entirety.

### FIELD OF THE INVENTION

The present invention relates to video telephone communications. More particularly, the present invention relates to systems and methods for incorporating video in voice-only call centers.

### BACKGROUND OF THE INVENTION

With the widespread ownership of computers capable of making video telephone calls over the Internet, as well as the introduction of so-called third generation (3G) cellular telephones, it has become desirable to provide customer service centers with the ability to receive and send video that is part of calls to the centers.

One problem with adding video capability to call centers is that many companies have already invested significant sums of money in non-video-capable call center equipment and those companies are not eager to replace that equipment with new equipment.

Thus, it is desirable to provide a mechanism through which video can be implemented in call centers while retaining existing call center equipment.

### SUMMARY OF THE INVENTION

In accordance with the present invention, systems and methods for incorporating video into voice-only call centers are provided. These systems and methods incorporate video by separating the video from the audio portion of incoming calls, routing the audio through the voice-only system to an agent telephone, routing the video separately from the audio to an agent terminal, and re-joining the video with the audio for outgoing portions of the call.

### BRIEF DESCRIPTION OF THE DRAWINGS

The invention is described below in more detail in connection with the following figures in which like references refer to like parts throughout and in which:

FIG. 1 is a high-level block diagram of a prior art telephone call center system;

FIG. 2 is a high-level block diagram of a system in accordance with one embodiment of the present invention;

FIG. 3 is a flow chart of a process for receiving video calls in connection with certain embodiments of the present invention;

FIG. 4 is a block diagram showing voice and video signals in a system in accordance with certain embodiments of the present invention; and

FIG. 5 is a block diagram of a system in accordance with certain embodiments of the present invention in which buffers are used to synchronize the audio and video signals.

### DETAILED DESCRIPTION OF THE INVENTION

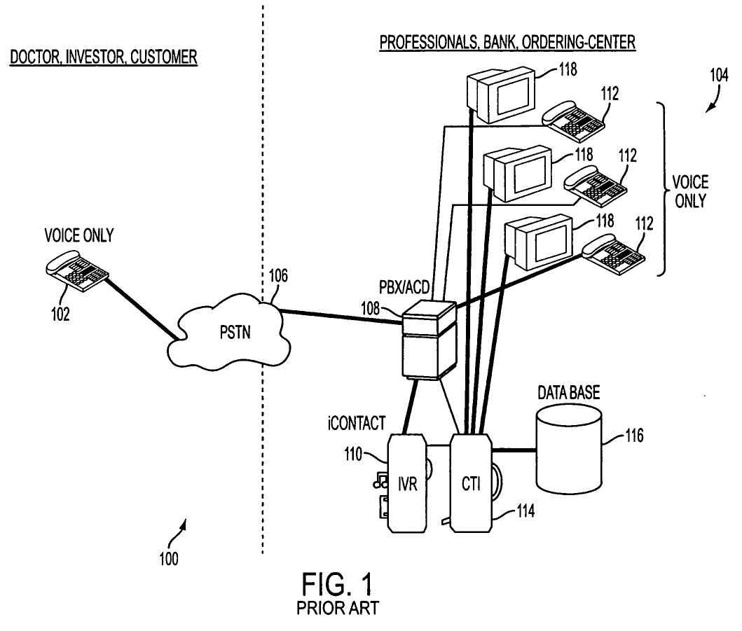

Turning to FIG. 1, a high-level block diagram of a prior art system 100 is shown. As illustrated, a doctor, investor, customer etc. may connect to a call center 104 for professionals, banks, order centers, etc. using a voice-only telephone 102 via a public switched telephone network 106. The call is received at private branch exchange (PBX)—automatic call director (ACD) equipment 108. The call may be connected to interactive voice response (IVR) system 110 to provide information or to route the call to an agent. PBX/ACD may then route the call to one of agent telephones 112. Computer telephony integration (CTI) equipment 114 may instruct the PBX/ACD as to how the call should be routed and provide data from database 116 to the corresponding agent terminal 118. As can be seen, call center 104 provides no functionality for video calls.

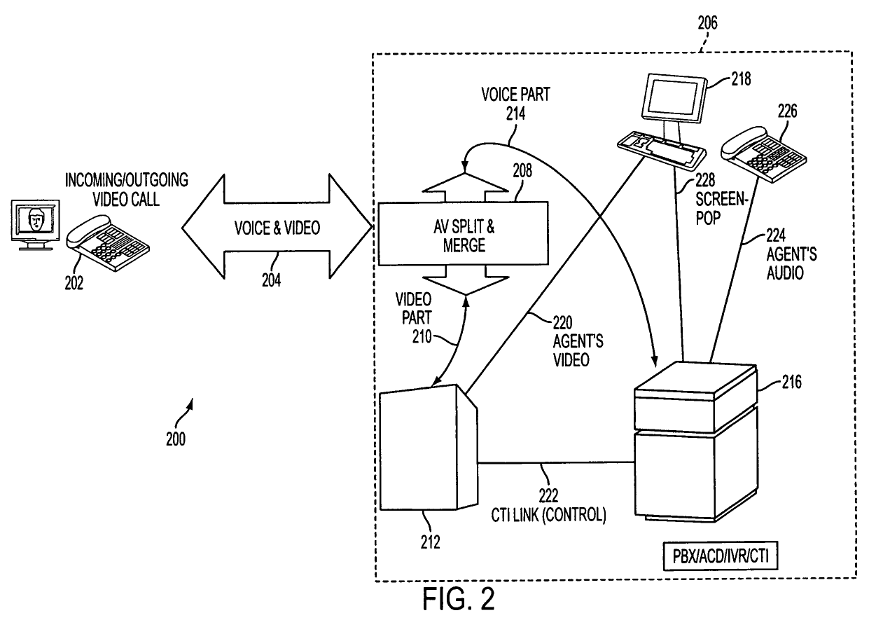

A system 200 that provides video capability in accordance with one embodiment of the present invention is shown in FIG. 2. As illustrated, a customer may receive a call from, or place a call to, a customer service center using a video enabled telephone 202. Video enabled telephone 202 may be any suitable telephone with video and audio capability. For example, telephone 202 may be a third-generation (3G) mobile telephone, a personal computer having video and audio capabilities and running software such as MICROSOFT NETMEETING, video conferencing equipment, etc. The call may be made using the H.323, SIP, or any other suitable protocol or connection method. The combined voice and video signal 204 is transmitted between telephone and call center 206 using any suitable transmission network such as wire and/or wireless telephone networks, cable television networks, and any IP network (e.g. the Internet).

At the call center, the call may be received or placed by split and merge unit 208. The voice and video parts of the call may then be split for incoming portions of the call, and merged for outgoing portions of the call at split and merge unit 208. Video part 210 is transmitted to, and received from, video processor 212, and may be in an H.323, SIP, or analog form, or in any other suitable protocol or connection method. Voice part 214 is transmitted to, and received from, voice-only call center equipment 216, and may be in an H.323, SIP, or analog form, or in any other suitable protocol or connection method.

Split and merge unit 208 may be any suitable hardware and/or software for receiving or placing calls, and splitting and merging video part 210 and voice part 214 as described herein. For example, split and merge unit 208 may be implemented using a multipoint control unit (MCU) (available from Radvision, Inc., Fairlawn, N.J., or any other suitable source) configured with one video and voice call, one voice only call, and one video only call connected as described above. If desired split and merge unit 208 may additionally be used to provide a video stream or file, or logo, screensaver, or avatar, to the call, perform voice recognition functions, and/or combine video part 210 and/or voice part 214 with other media. For example, a video clip (or longer video content) may be presented to a customer with an image of a call center agent displayed in a picture-in-picture type display in a corner of the customer's display screen. In such case, the split and merge unit 208 may combine the two video signals.

Video processor 212 may be any suitable equipment for connecting video part 210 to an agent's display terminal 218 via an agent's video signal 220 and may include logic for transmitting and receiving video signals in any known format using any known codec and directing the signals to a selected terminal 218 based on control information 222 from equipment 216. In certain embodiments, processor 212 may independently determine which agent to route video signal 220 to by operating a similar algorithm to the algorithm used to select agents on equipment 216. Processor 212 may also perform any suitable processing on video part 210.

Voice-only call center equipment 216 may be any suitable equipment such as an ASPECT CTI on top of a Tadiran ACD, a GENESYS CTI and an ALCATEL OMNIPIX ACD, etc. Equipment 216 preferably connects voice part 214 to agent's telephone 226 via audio signal 224. Equipment 216 may also select which agent is connected to which customer, provide interactive voice response (IVR) functions, provide information to, and receive information from, the agent's terminal 218 via screen populate signal 228, etc.

Terminal 218 may be any suitable equipment for sending and receiving video signals, and may also include the capability to allow the agent to see and modify data relating to the customer. Similarly, telephone 226 may be any suitable equipment for sending and receiving agent's audio signal 224 as is known in the art.

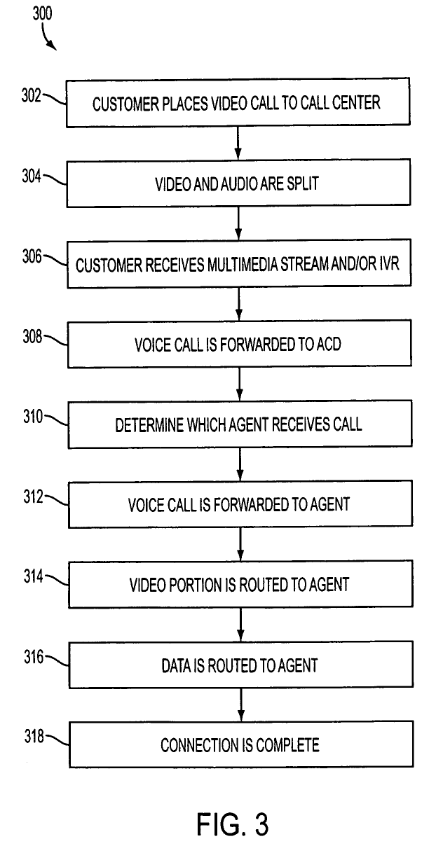

FIG. 3 illustrates a process 300 for receiving a video call at a call center in accordance with one embodiment of the present invention. As shown, process 300 begins by a customer placing a video call to a call center at step 302. As described in connection with FIG. 2, this call may be placed using any suitable device. As step 304, the call is received and the video and audio for the inbound portions of the call are split by split and merge unit at the call center. This same function merges the video and audio for outbound portions of the call. Next, at optional step 306, the customer may receive a multimedia stream and/or an IVR menu. At step 308, the voice portion of the call is routed to an ACD. The ACD then determines to which agent the call will be routed at step 310. This routing may be based on responses to an IVR menu or any other suitable consideration. Next, the voice portion of the call is routed to the determined agent at step 312, the video portion is routed to the agent at step 314, and corresponding data is routed to the agent at step 316. Obviously steps 312, 314, and 316 may be performed concurrently or in any suitable order. Finally, at step 318, the call connection is established.

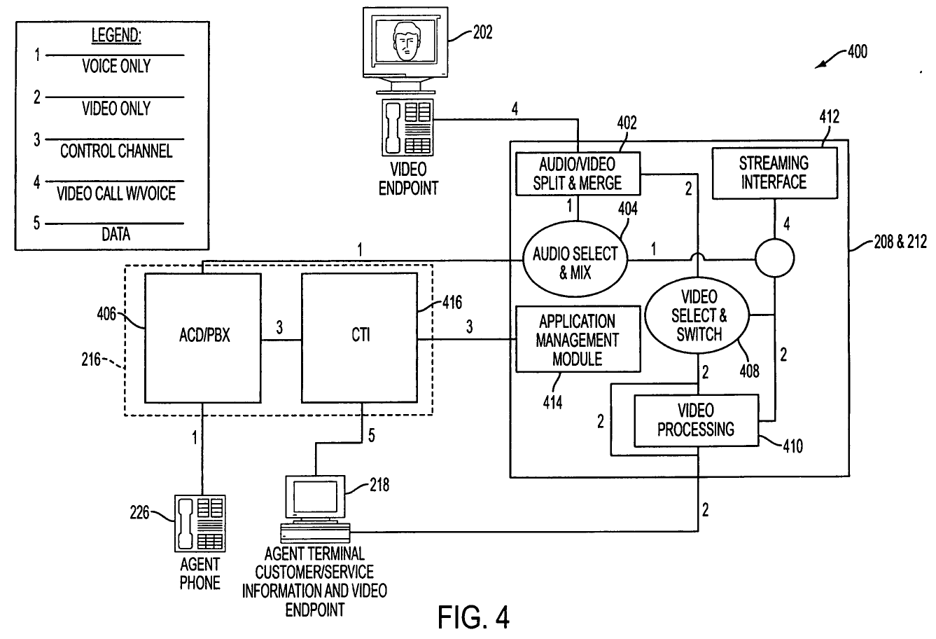

FIG. 4 illustrates how voice and video signals may be separated in certain embodiments of the present invention. As shown, system 400 includes a video enabled telephone 202, split and merge unit 208 and video processor 212, voice-only call center equipment 216, agent telephone 226, and agent terminal 218 as described above in connection with FIG. 2. A video telephone call signal 4, which may include a video portion, an audio portion, and a data collaboration portion, may come in from telephone 202 to split/merge mechanism 402 (which may be any suitable mechanism for splitting and merging audio and video). Telephone call signal 4 may be separated into any number of desired signals. For example, telephone call signal 4 may be separated into an audio signal 1 and a video signal 2. The audio signal 1 may then be sent via audio select and mix circuit 404 to ACD/PBX 406 to agent telephone 226. The video signal 2, which may contain both the video portion and the data collaboration portion of the telephone call signal 4, may be sent via video select and switch circuit 408 and video processing unit 410 to terminal 218. Alternatively, telephone call signal 4 may be separated out into three different signals and sent to agent telephone 226 and agent terminal 218 in a suitable manner.

Audio select and mix circuit 404 determines whether audio from streaming interface 412 (which may be connected to any suitable source of streaming content) and/or ACD/PBX 406 is connected to telephone 202, and may be any suitable hardware and/or software. Video select and switch circuit 408 determines to which agent to connect the video signal and may also connect the signal to streaming interface 412 so that video may be provided to telephone 202, and may be any suitable hardware and/or software. Video processing unit 410 may perform any suitable or necessary processing on the video signal for connecting telephone 202 to terminal 218 and/or streaming interface 412. As shown, unit 410 may be bypassed if appropriate.

As can also be seen, a control signal 3 is passed between ACD/PBX 406, CTI 416, and application management module 414. This control signal may indicate to ACD/PBX 406, CTI 416, and module 414 which agent is connected to the call and information about the caller. In response to the information, CTI 416 may then provide corresponding data 5 about the customer to terminal 218, and module 414 may determine how circuits 404 and 408 connect the audio and video signals.

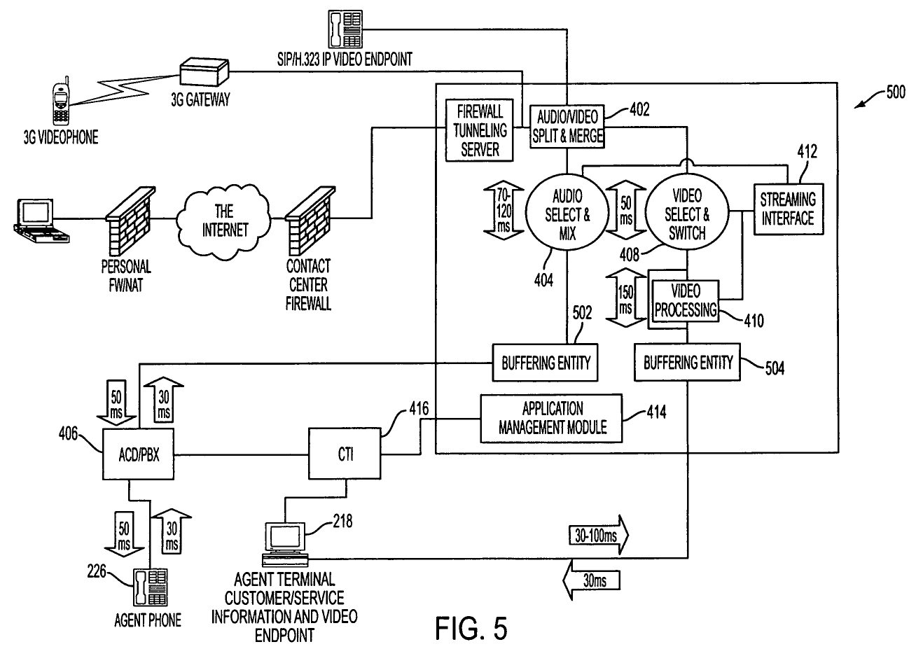

As shown in FIG. 5, it may be desirable and/or necessary to use buffers 502 and 504 to compensate for different audio and video delays in the components of a system 500 so that the audio and video signals are synchronized. For example, buffer entity 502 may impose a delay on the path between split/merge mechanism 402, audio select and mix circuit 404, ACD/PBX 406, and agent phone 226 so that it matches the delay on the path between split/merge mechanism 402, video select and switch circuit 408, video processing unit 410, and agent terminal. Additionally or alternatively, buffering entity 504 may impose a delay in its path. In this way, the video and voice paths can be kept in synchronization. This buffering may be controlled on a call-by-call basis, or may be controlled on any other suitable basis.

Although the present invention is described herein a being between a customer and a customer service center, it should be apparent that the present invention could be implemented for use between any suitable sets of parties. For example, the invention could be used to facilitate calls between potential customers and sales representatives, between people being polled and polling organizations, employees and their employers, etc.

Also, although the present invention is described above in connection with a two-way video signal, the present invention may be implemented with video in only one direction. For example, the video signal may only be provided from the agent to the customer when telephone 102 does not include a video camera. As another example, the video signal may only be provided from the customer to the agent when the customer wishes to show something to the agent (e.g., damaged products). As yet another example, the video signal may only be provided to the customer and include a screensaver image, a logo image, an avatar, a streaming content such as a video clip showing a commercial for the agent's company, or any other desired video signal.

Although the present invention has been described above in connection with specific illustrative embodiments, it should be understood that the invention may be implemented using various alternate features and that the invention is limited only by the claims which follow.

What is claimed is:

1. A method for implementing a video telephone call in conjunction with a voice-only telephone call center system, comprising:
splitting the video telephone call into a video part and a voice audio part;
coupling the voice part through a PBX to a telephone of a selected agent; and
coupling the video part to a terminal of the selected agent.

2. The method as claimed in claim 1, further comprising:
using at least one buffer to synchronize the video part and the voice part.

3. The method as claimed in claim 1, further comprising:
processing the video part.

4. The method as claimed in claim 1, wherein the video telephone call is made by a caller using a third generation (3G) mobile telephone.

5. The method as claimed in claim 1, wherein the video telephone call is made using an internet protocol (IP) network.

6. The method as claimed in claim 1, further comprising presenting a video stream, a logo, a screensaver, or an avatar on the video part.

7. The method as claimed in claim 1, further comprising presenting a combination of two video signals on the video part.

8. The method as claimed in claim 1, further comprising presenting an audio stream on the voice part.

9. The method as claimed in claim 1, further comprising merging the video part and the voice part.

10. A system for implementing a video telephone call in conjunction with a voice-only telephone call center system, comprising:
means for splitting the video telephone call into a video part and a voice audio part;
means for coupling the voice part to a telephone of a selected agent; and
means for coupling the video part to a terminal of the selected agent.

11. The system as claimed in claim 10, further comprising:
means for using at least one buffer to synchronize the video part and the voice part.

12. The system as claimed in claim 10, further comprising:
means for processing the video part.

13. The system as claimed in claim 10, wherein the video telephone call is made by a caller using a third generation (3G) mobile telephone.

14. The system as claimed in claim 10, wherein the video telephone call is made using an internet protocol (IP) network.

15. The system as claimed in claim 10, further comprising:
means for presenting a video stream, a logo, a screensaver, or an avatar on the video part.

16. The system as claimed in claim 10, further comprising:
means for presenting a combination of two video signals on the video part.

17. The system as claimed in claim 10, further comprising:
means presenting an audio stream on the voice part.

18. The system as claimed in claim 10, further comprising
means for merging the video part and the voice part.

19. A system for implementing a video telephone call in conjunction with a voice-only telephone call center system, comprising:
a split and merge unit that splits the video telephone call into a video part and a voice audio part, that couples the voice part through a PBX to a telephone of a selected agent, and that couples the video part to a terminal of the selected agent.

20. The system as claimed in claim 19, further comprising:
a buffer that synchronizes the video part and the voice part.

21. The system as claimed in claim 19, further comprising:
a processor that processes the video part.

22. The system as claimed in claim 19, wherein the video telephone call is made by a caller using a third generation (3G) mobile telephone.

23. The system as claimed in claim 19, wherein the video telephone call is made using an internet protocol (IP) network.

24. The system as claimed in claim 19, wherein the split and merge unit presents a video stream, a logo, a screensaver, or an avatar on the video part.

25. The system as claimed in claim 19, wherein the split and merge unit presents a combination of two video signals on the video part.

26. The system as claimed in claim 19, wherein the split and merge unit presents an audio stream on the voice part.

27. The system as claimed in claim 19, wherein the split and merge unit merges the video part and the voice part.
